(19) United States
(12) Patent Application Publication
(10) Pub. No.: US 2012/0209481 A1
(43) Pub. Date: Aug. 16, 2012

(54) BRAKE TEST METHOD

(76) Inventors: David F. Rindfleisch, Dubuque, IA (US); Carl R. Starkey, Dubuque, IA (US)

(21) Appl. No.: 13/027,963

(22) Filed: Feb. 15, 2011

(51) Int. Cl. B60W 10/06; B60W 10/10; B60W 10/18; B60W 30/18

(52) U.S. Cl. 701/54

(57) ABSTRACT

A ground engaging vehicle having an engine, a transmission driven by the engine, a controller, and a braking system. The controller is communicatively coupled to the engine and the transmission. The braking system is communicatively coupled to the controller. The controller is configured to execute testing steps to evaluate the braking system. The braking system includes a service brake and/or a parking brake. The testing steps executed by the controller include applying either the service brake or the parking brake; engaging the transmission to drive the vehicle; significantly increasing power output from the engine to the transmission, and sensing whether the transmission has an output movement that is above a predetermined amount.

### FIELD OF THE INVENTION

The present invention relates to a brake testing method for a vehicle, and, more particularly, to a vehicle brake testing method for a wheeled or high-speed rubber tracked vehicle.

### BACKGROUND OF THE INVENTION

A brake is a device designed to inhibit motion, and most commonly uses a friction element to convert kinetic energy into heat. Brakes are generally applied to rotating axles or wheels. Almost all wheeled vehicles have a brake of some sort. The effective applying of a brake typically causes a piston to push a frictional pad toward a surface, such as a brake disc, causing the rotating wheel to slow down.

It is generally accepted that brake system defects are responsible for a high number of vehicle accidents. An analysis by the Indiana University Institute for Research and Public Safety of the accidents reported for a five-year period covered by the report (1972-1977) indicates that the vehicles' braking system was definitely at fault in nearly 3% of the accidents, probably at fault in over 5% of the accidents, and possibly at fault in close to 20% of the reported accidents. Brake inspection and testing is given a high priority in the states that have motor vehicle inspection programs. A typical brake test includes measuring the vehicle's stopping power. Typically, the vehicle's wheels are placed on a constant speed, torque motor driven pair of rollers. The brakes are applied and the magnitude of the torque drive required to rotate the rollers with the brakes applied is used as an indication of the vehicle braking force.

What is needed in the art is repeatable, efficient brake test that can be performed apart from a test station on a vehicle that is in service.

### SUMMARY

The present invention provides a brake test system and method for a ground-engaging vehicle and, more particularly, a brake test system for an articulated dump truck.

The invention in one form is directed to a ground-engaging vehicle having an engine, a transmission driven by the engine, a controller, and a braking system. The controller is communicatively coupled to the engine and the transmission. The braking system is communicatively coupled to the controller. The controller is configured to execute testing steps to evaluate the braking system. The braking system includes a service brake and/or a parking brake. The testing steps executed by the controller include applying either the service brake or the parking brake; engaging the transmission to drive the vehicle; significantly increasing power output from the engine to the transmission, and sensing whether the transmission has an output movement that is above a predetermined amount.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a schematical illustration of a vehicle incorporating an embodiment of the brake system testing method of the present invention; and

FIG. 2A-C are a schematical flowchart illustrating the steps of the invention utilized with the vehicle of FIG. 1.

Corresponding reference characters indicate corresponding parts throughout the several views. The exemplification set out herein illustrates one embodiment of the invention and such exemplification is not to be construed as limiting the scope of the invention in any manner.

### DETAILED DESCRIPTION

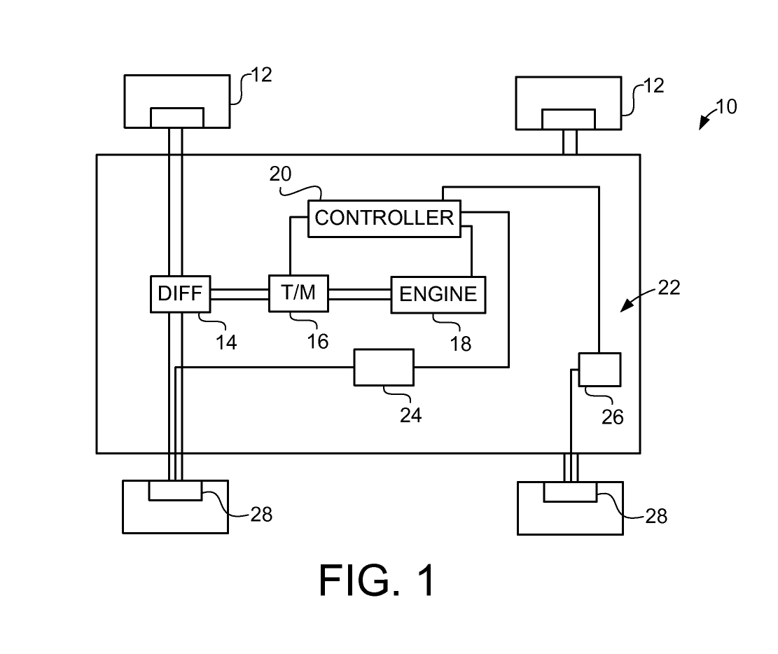

Referring now to the drawings, and, more particularly, to FIG. 1, there is illustrated, in a schematical fashion a vehicle 10 having ground engaging devices 12, a differential 14, a transmission 16, an engine 18, a controller 20, a braking system 22 that includes a service brake 24, a parking brake 26, and brake pads 28. Vehicle 10 may be in the form of an articulated dump truck or other ground engaging vehicle utilized for construction, agriculture, forestry, mining and other related vehicles. Ground engaging devices 12 are in the form of wheels 12, as illustrated, but may be in the form of a track, such as a high-speed rubber track on vehicle 10. A differential 14 may be utilized to transfer the rotational power provided from engine 18, the power being directed to ground engaging devices 12. Transmission 16 converts the rotational speed of engine 18 into a different output speed and power, directing the rotational power to differential 14. Engine 18 can be an internal combustion diesel engine that provides an output torque to transmission 16, which directs rotary power to ground engaging devices 12. Alternatively, engine 18 may provide power that is then directed in a fluid manner to ground engaging devices 12, such as utilizing a hydraulically driven system. For the purposes of clarity, only two wheels 12 are shown being driven, although it is also anticipated that the present invention relates to vehicles having another number of wheels or tracks being driven by engine 18.

Controller 20 may be integral with engine 18 and may be in the form of an engine control device or as illustrated controller 20 may be a chassis control unit (CCU), here generically referred to as controller 20. Controller 20 is interconnected with transmission 16, engine 18, service brake 24, and parking brake 26. Controller 20 can alter the speed and power output of engine 18, engage transmission 16 into a selected gear, and apply service brake 24 and/or parking brake 26.

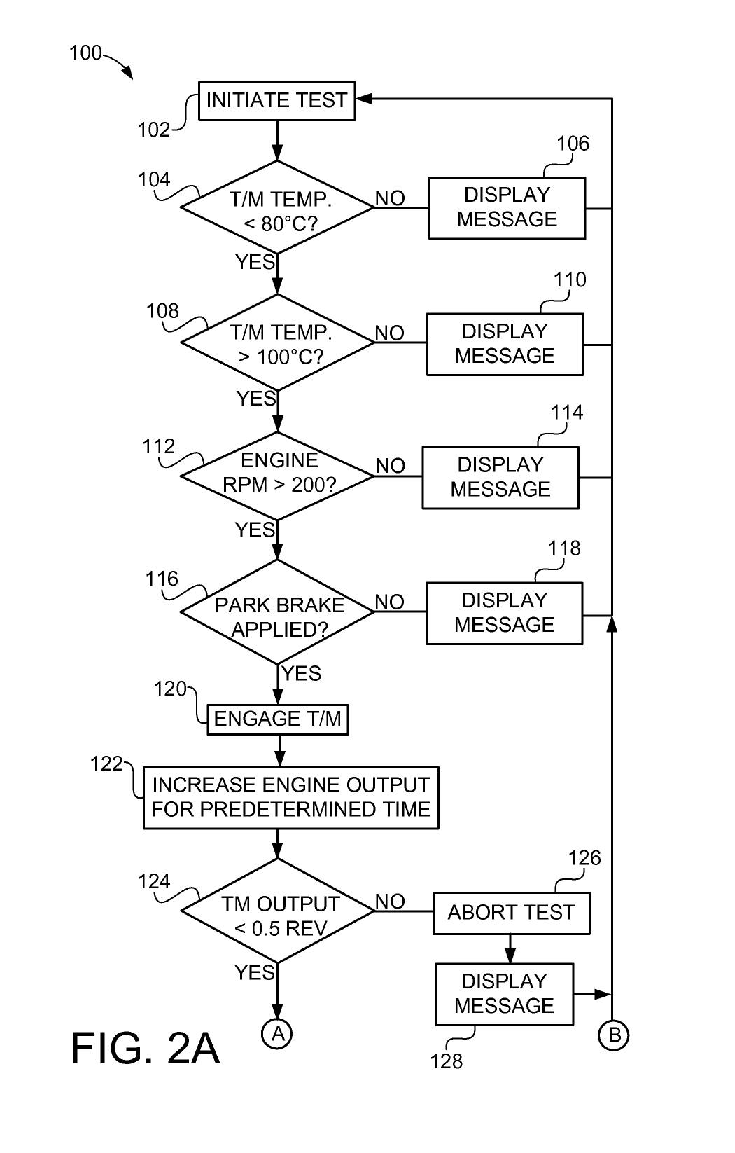

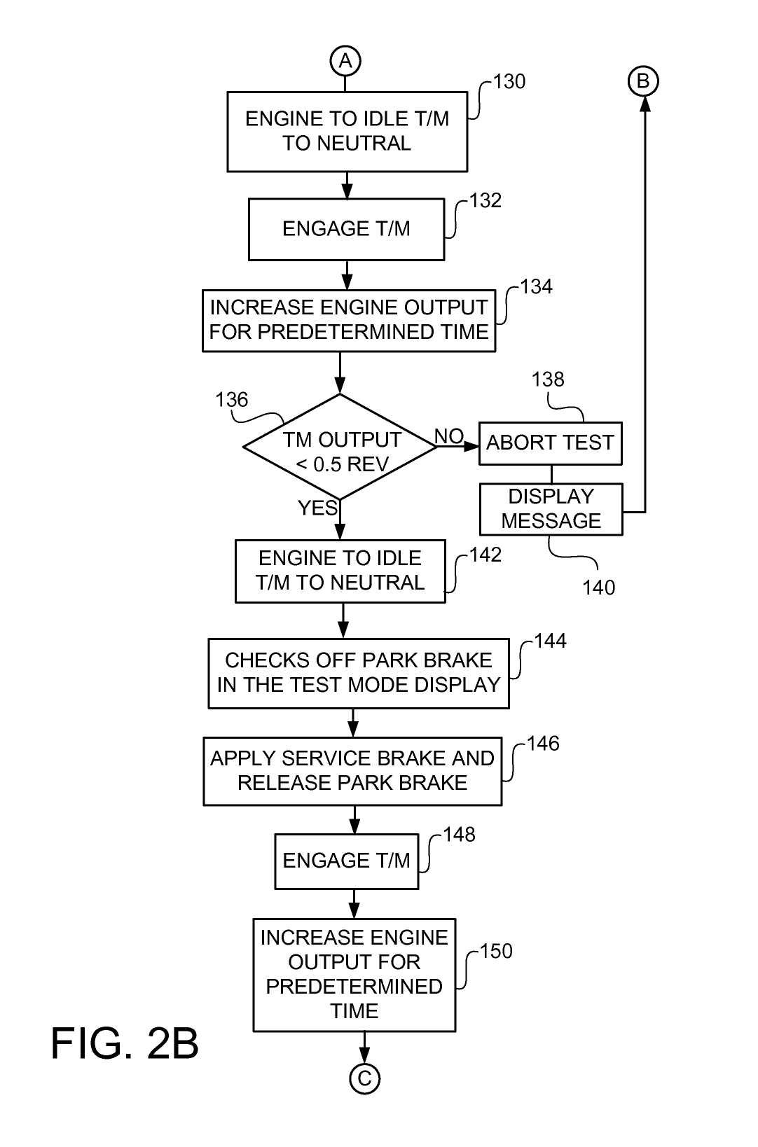

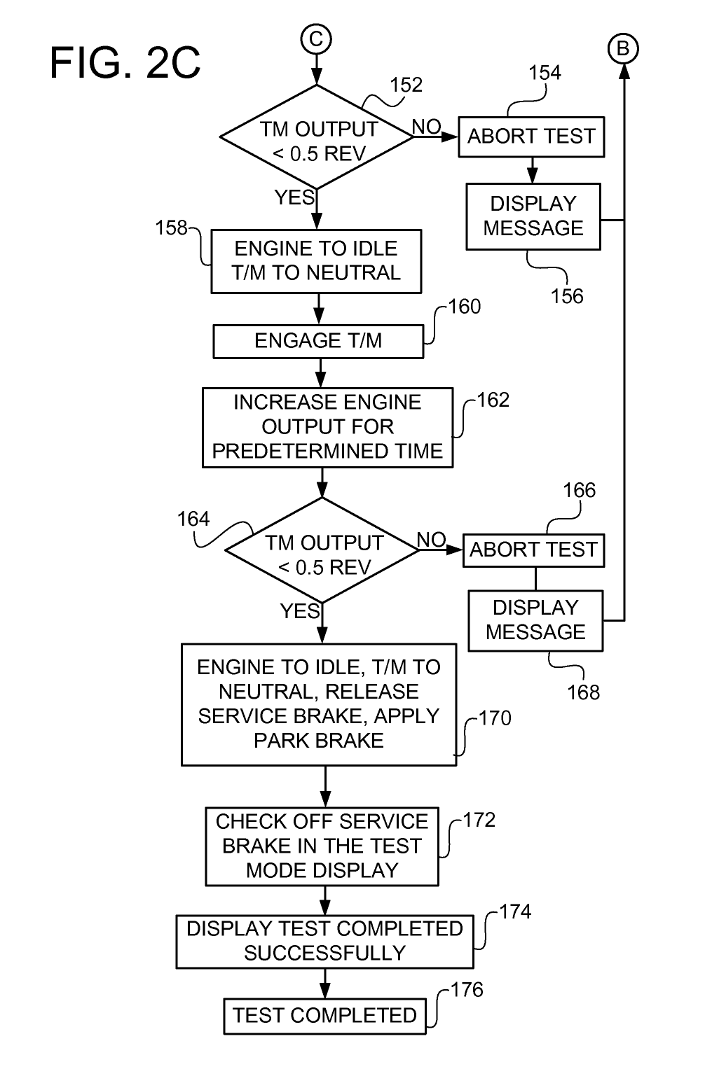

Now, additionally referring to FIG. 2A-C, there is illustrated a method 100 carried out by controller 20 of vehicle 10. The operator can initiate a periodic verification of the functioning of brake system 22 by initiating method 100 at step 102. At step 102, the operator may start the testing mode upon being prompted by controller 20, indicating that such a test may be needed before complete control of vehicle 10 is available to the operator. Upon initiation of the test at step 102, method 100 tests to ensure that the transmission temperature is at a proper operating range between, in this case, 80° C. to 100° C. This occurs at steps 104 and 108 although other temperatures are contemplated. If the temperature is below 80° C., then method 100 proceeds to step 106 where a message is displayed to the operator, indicating that the transmission needs to be warmed up before testing of the brakes can occur and indicates that the brake testing should be restarted when this condition exists. In a like manner, if the transmission temperature is above 100° C., a message is provided at step 110 indicating that the transmission needs to be cooled down before the running of the brake test.

At step 112, a test is undertaken to ensure that engine 18 is running by testing to see if the rpm is above 200. If the engine rpm is below 200, then a message is sent at step 114 and the display will indicate that the engine should be started and that the brake test be restarted. If the engine is running, then method 100 proceeds to step 116 in which it is tested to see if parking brake 26 has been applied. If parking brake 26 has not been applied, then method 100 proceeds to step 118 and a message is displayed indicating that the parking brake 26 should be applied and that the test 100 should be restarted. Alternatively, if vehicle 10 is configured such that parking brake 26 can be applied by controller 20, then controller 20 will apply parking brake 26.

If parking brake 26 has been applied at step 116, then transmission 16 is engaged into a preselected gear, such as third gear forward, and then, at step 122, the speed of engine 18 is increased to a predetermined level for a predetermined time. For example, the engine may be increased to 100% of the top rated speed and held there for a predetermined time, such as four seconds. During the execution of the full speed engine output at step 122, controller 20 tests to see if transmission 16 is moving at step 124. The movement of transmission output 16 would indicate that one or more brakes 28 are allowing movement of ground engaging devices 12. If transmission output is less than one-half of a revolution, although other amounts of rotation are also contemplated, at step 124, method 100 proceeds to step 130. Otherwise, if transmission 16 rotates one-half revolution or more then the test is aborted at step 126 and a message is displayed at step 128 indicating that vehicle 10 should be taken out of service and that the parking brake troubleshooting section is referred to on the display. If the transmission 16 rotated less than one-half of a revolution at step 124, then, at step 130, the engine 18 is reduced to an idle speed and transmission 16 is placed in neutral.

Steps 132, 134, 136, 138, and 140 may be identical or substantially similar to steps 120, 122, 124, 126, and 128 respectively. This allows a repeat of the parking brake test carried out by the initial set of steps, except at step 134 transmission 16 is engaged in a reverse gear such as 3^{rd} gear, reverse. This substantially repeated test, then, if failed at step 136, leads to the aborting of the test at step 138 and the display of a message at step 140, which is the same as the message at step 128. If transmission 16 has an output of less than one-half revolution at step 136, then method 100 proceeds to step 142 in which engine 18 is reduced to an idle speed and transmission 16 is placed in neutral. At step 144, the parking brake indicator on the display in vehicle 10 indicates that the parking brake test has been passed.

At step 146, service brake 24 is applied and parking brake 26 is released. This may be accomplished by controller 20 or by some interaction of the operator, in which case, a message will be sent to the display telling the operator to apply the service brake and/or release the parking brake. At step 148, transmission 16 is engaged, for example, in third gear forward. At step 150, the engine speed of engine 18 is increased to 100% and held there for a minimum of four seconds and, again at step 152, the transmission is checked for rotation and, if the rotation is greater than or equal to one-half of a revolution, then method 100 proceeds to step 154 where the test is aborted and a message displayed at step 156 indicating that vehicle 10 should be taken out of service and a reference to the service brake troubleshooting section in the operator's manual is displayed. If the transmission moves less than one-half of a revolution, then engine 18 is returned to idle speed and the transmission is placed in neutral at step 158. At step 160, the transmission is engaged into reverse third gear and then, at step 162, engine 18 is increased in speed to 100% for a minimum of four seconds. If transmission 16 rotates for more than half of a revolution at step 164, then method 100 proceeds to step 166 where the test is aborted and step 168 in which a message is displayed, which may be identical to the message displayed at step 156. If transmission 16 rotates for less than one-half of a revolution at step 164, then the engine is brought to idle and transmission 16 is placed into neutral and service brake 24 is released. At step 172, the display indicates that the service brake has passed and it is checked off on the test mode display. At step 174, the display indicates that the test has been successfully completed and method 100 proceeds to step 176 in which the test is completed and terminated. It should be noted that whenever the test is aborted, the engine speed is immediately reduced and steps may be taken to stop any movement of vehicle 10. Additionally, the sensing of rotation of transmission 16 goes on while engine speed of engine 18 is being increased so that, if any movement of the transmission, even with less than full power output from engine 18, is detected beyond the predetermined allowable movement, then method 100 proceeds to abort the test. So, while indicated in the flow chart as individual steps, controller 20 monitors the movement of transmission 16 during the increased output of engine 18 before and during the carrying out of full power output of engine 18 during the predetermined time of four seconds.

Method 100 automatically applies a driving force against the service brake and the parking brake while detecting machine or transmission motion to confirm that both service brake 24 and parking brake 26 have adequate holding torque. Failure of the test, results in the operator being instructed to take vehicle 10 out of service due to the detection of inadequate brake function.

Advantageously, the inventive test mode provides a verification of the service and parking brake performance. Further, the test mode may be fully automatic, only requiring the operator to engage the test mode at a desired interval since the previous testing. Further, the method of the present invention provides for daily verification of braking performance that may be required in some operating environments, such as at a mining operation. Yet still further, the present invention takes advantage of electronic brake valve to automatically apply the service brakes.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A ground engaging vehicle, comprising:
an engine;
a transmission driven by said engine;
a controller communicatively coupled to said engine and said transmission; and
a braking system communicatively coupled to said controller, said controller being configured to execute testing steps to evaluate said braking system, said braking system including at least one of a service brake and a parking brake, said testing steps including:
applying one of said service brake and said parking brake;
engaging said transmission to drive the vehicle;
significantly increasing power output from said engine to said transmission; and
sensing whether said transmission has an output movement that is above a predetermined amount.

2. The ground engaging vehicle of claim 1, wherein said testing steps further include the steps of:
reducing said power output from said engine by reducing a speed of said engine; and
repeating said significantly increasing step and said sensing step.

3. The ground engaging vehicle of claim 2, wherein said testing steps are repeated and carried out on both said service brake and said parking brake by separately applying each in said applying step.

4. The ground engaging vehicle of claim 3, wherein said step of significantly increasing power output from said engine increases said engine speed to substantially 100% of a rated engine speed.

5. The ground engaging vehicle of claim 4, wherein a predetermined time elapses between said engine speed being at substantially 100% of said rated engine speed until said reducing step is executed, said predetermined time being approximately 4 seconds.

6. The ground engaging vehicle of claim 1, wherein said predetermined amount is approximately one half of a revolution on an output shaft of said transmission.

7. The ground engaging vehicle of claim 6, wherein said testing steps further includes a step of ensuring said transmission is operating within a predetermined temperature range.

8. The ground engaging vehicle of claim 7, wherein said predetermined temperature range is from approximately 80° C. to approximately 100° C.

9. The ground engaging vehicle of claim 1, wherein said testing steps further include the step of reporting failure of the vehicle to pass said testing steps if said output movement is above said predetermined amount.

10. The ground engaging vehicle of claim 9, wherein said testing steps further include the step of aborting said testing steps in the event said output movement is above said predetermined amount.

11. A brake testing method of a braking system of a ground engaging vehicle having an engine, a transmission driven by the engine, a controller communicatively coupled to the engine and the transmission, the braking system being communicatively coupled to the controller, the controller being configured to execute steps of the method, the method comprising the steps of:
applying one of the service brake and the parking brake;
engaging the transmission to drive the vehicle;
significantly increasing power output from the engine to the transmission; and
sensing whether the transmission has an output movement that is above a predetermined amount.

12. The method of claim 11, wherein further including the steps of:
reducing said power output from said engine by reducing a speed of said engine; and
repeating said significantly increasing step and said sensing step.

13. The method of claim 12, wherein said steps are repeated and carried out on both said service brake and said parking brake by separately applying each in said applying step.

14. The method of claim 13, wherein said step of significantly increasing power output from said engine increases said engine speed to substantially 100% of a rated engine speed.

15. The method of claim 14, wherein a predetermined time elapses between said engine speed being at substantially 100% of said rated engine speed until said reducing step is executed, said predetermined time being approximately 4 seconds.

16. The method of claim 11, wherein said predetermined amount is approximately one half of a revolution on an output shaft of said transmission.

17. The method of claim 16, further including a step of ensuring said transmission is operating within a predetermined temperature range.

18. The method of claim 17, wherein said predetermined temperature range is from approximately 80° C. to approximately 100° C.

19. The method of claim 11, further comprising the step of reporting failure of the vehicle to pass said testing steps if said output movement is above said predetermined amount.

20. The method of claim 19, further comprising the step of aborting method in the event said output movement is above said predetermined amount.
